(19) United States
(12) Patent Application Publication
(10) Pub. No.: US 2011/0095522 A1
(43) Pub. Date: Apr. 28, 2011

(54) QUICK CONNECTION UNION

(75) Inventors: Philippe Legrand, St. Gervais la Foret (FR); Pascal Hausmann, Vineuil (FR)

(73) Assignee: DELPHI TECHNOLOGIES, INC., TROY, MI (US)

(21) Appl. No.: 12/377,272

(22) PCT Filed: Aug. 10, 2007
(86) PCT No.: PCT/FR2007/051810

§ 371 Date: Jan. 14, 2011

(30) Foreign Application Priority Data
Aug. 16, 2006 (EP) 06291313.2

(51) Int. Cl. F16L 37/00

(52) U.S. Cl. 285/81

(57) ABSTRACT

The union includes a cylindrical hollow body having at a rear end means for connection to a pipe, and at a front end a tubular nozzle able to be received in a housing formed in a bore on the periphery of an injector, the body bearing means for retaining the tubular nozzle in the housing. The retaining means include two elastic tabs in an arc of circle extending on the periphery of the body concentrically with the axis (A-A) of this. Each of the tabs defines with the periphery of the said body a slot in an arc of circle open on one side. The tabs are able to co-operate with a groove provided inside the bore of the injector.

The union in accordance with the invention is used to connect an injector of an internal combustion engine to a fuel return pipe.

### TECHNICAL FIELD

The present invention relates to a quick connection union, in particular a union used in a fuel supply system including a plurality of injectors supplying an internal combustion engine, in particular a diesel engine.

### BACKGROUND OF THE INVENTION

A union of this type is associated with each injector and has the function of connecting it to a pipe for return of fuel to a fuel tank. The injectors are supplied using a high pressure pump and the fuel return is in fact relatively large. This use of a quick connection union to a fuel injector is itself well known and will not be explained in more detail.

### SUMMARY OF THE INVENTION

However, several types of such quick connection unions are known which are all provided with means for connection to a fuel return pipe, with a tubular nozzle which can be introduced into a bore formed in an injector to form a return fuel outlet, and with means for retaining the nozzle in this bore.

FIGS. 1 to 5 show the structure and use of such a quick connection union 1 currently used to connect an injector 2 to a return pipe (not shown). At one of its ends, the injector 2 includes an injection nozzle 3 and at another end an axial intake 4 for fuel at high pressure.

FIGS. 3 and 4 show the quick connection union 1 seen from the side and seen from above respectively.

The union 1 includes a cylindrical hollow body 5 which has at a rear end connection means 6, 7 to a fuel return pipe (not shown in the figures).

At a front end, the union 1 includes a tubular nozzle 8 bearing sealing means in the form of an O-ring seal 9. This tubular nozzle 8 can be received in a bore 10 in the injector 2 to rest in a housing 11 at the bottom of the bore in communication with the inside of the injector in order to receive the return fuel.

The body 5 of the union 1 bears means for retaining the tubular nozzle 8 in the housing 11. These retaining means include a frame 12 carrying two elastic arms 13 forming forward extensions of the frame.

The frame 12 is generally rectangular and grips the connection means 6, 7 at the back end and the nozzle 8 at the front end. The side of the frame 12 which grips the nozzle 8 has a curved shape matching the outer surface of the injector 2 to press against this when the nozzle is inserted in the bore 10.

The two elastic arms 13 extend on either side of the nozzle 8 substantially parallel with each other to snap onto the injector 2 when the nozzle 8 is introduced into the bore 10. To improve the grip of the arms 13 on the injector 2, this has on its periphery two flats 14 parallel with each other against which the arms can rest and the ends of these are bent towards each other so as to bear against the outer face of the injector and thus retain the union in position against this.

The quick connection union 1 which has just been described is, however, very limited in its use, since it supposes that the bore 10 is perpendicular to the axis of the injector 2 and that there is sufficient room behind this to allow passage of the arms 13 for them to snap on.

In other words, it is impossible to use this union when it is required, for example due to the engine environment, to place the union at a certain angle simultaneously in one or more planes as illustrated by the angles α1 and α2 shown in FIGS. 11 and 12. The need to place the union at an angle particularly occurs when the fuel intake is radial relative to the axis of the injector.

Other quick connection unions are also known which employ, as means for retaining the union on the injector, a clip, a first branch of which is introduced into a bore in order to be housed in a groove in the nozzle of the union, while its second branch, which has a catching means at its end, enters a cavity to thus retain the clip in place, while allowing its extraction to release the nozzle. However, this solution is relatively complex in its implementation, since it requires a large number of high-precision machining operations.

The aim of the invention is to propose a quick connection union which can be installed at practically any angle to the axis of the injector, which is simple to manufacture and which can easily be installed and uninstalled. In addition, in accordance with one of the embodiments, this union includes dual security preventing any leak of fuel caused by untimely release of the retaining means.

The object of the invention is a quick connection union able to connect an injector of an internal combustion engine to a fuel return pipe, including a generally cylindrical hollow body presenting at a rear end means for connection to the said fuel return pipe, and at a front end a tubular nozzle bearing sealing means and able to be received in a housing formed in a bore on the periphery of the said injector in communication with the inside of this, the said body bearing means for retaining the said tubular nozzle in the said housing, characterised by the fact that the said retaining means include two elastic tabs in an arc of circle extending on the periphery of the said body substantially concentrically with its axis, each of the said tabs defining with the periphery of the said body a slot in an arc of circle open on one side, and by the fact that the said tabs are able to co-operate with a groove provided inside the said bore of the injector.

In accordance with further characteristics of the invention:
at a free end the said tabs carry a catching organ in the form of a protuberance able to enter the said groove;
a fixed end of each tab is joined to the said body by means of a radial flange on the said body;
the said radial flange of a first tab is arranged diametrically opposite the flange of a second tab;
the thickness of the said protuberance substantially corresponds to the thickness of the said slot;
the said protuberance has an outwardly domed shape;
the said tabs are dimensioned to protrude from the said bore when the said nozzle is inserted in it;
the forward bending of the tabs is delimited by a collar on the periphery of the said body;
the said collar is able to act as a stop against a circular shoulder in the said bore on introduction of the said nozzle into this;
the said body, the said connection means, the said tabs, the said flanges and the said collar are made in one piece;
the said union also includes intercalary organs for locking the tabs, these locking organs having a shape of an arc of circle and being able to be inserted in a respective slot of the said slots, following the introduction of the said nozzle into the said bore;
the said locking organs are joined to the lower face of a ring mounted slidingly on the said body;
the said locking organs define between them downwardly open cavities able to receive the said flanges on introduction of the said locking organs into the said slots;
the said ring is made of an elastic material and is split so as to allow it to be mounted on the said body from the side;
the said locking organs extend in the said slots and as far as the next tab.

The invention also relates to a quick connection union defined above, characterised by the fact that it is associated with a union having the characteristics mentioned above, and by the fact that it is suitable to co-operate with retaining means provided on the union.

### BRIEF DESCRIPTION OF THE DRAWINGS

Other characteristics and advantages of the invention will become apparent from the following description of a non-limiting embodiment of the invention, with reference to the attached figures in which:

FIGS. 1 and 2 show a side view, partially in section, and a view from above, respectively, of an injector designed to receive a known quick connection union;

FIGS. 3 and 4 show a side view and a view from above, respectively, of a known connection union able to be mounted on the injector shown in FIGS. 1 and 2;

FIG. 5 shows diagrammatically seen from above the union of FIGS. 3 and 4 mounted on the injector of FIGS. 1 and 2;

FIG. 6 shows a partial view, partially in section, of an injector able to receive a quick connection union in accordance with the invention;

FIG. 7 is a side view, partially in section, of a quick connection union in accordance with the invention;

FIG. 8 is a perspective view of the union of FIG. 7;

FIG. 9 is a view in section along the line IX-IX of FIG. 7;

FIG. 10 is a perspective view of intercalary locking means in accordance with the invention;

FIG. 11 is a view from above of the union of FIGS. 7 and 8 mounted on the injector of FIG. 6;

FIG. 12 is a side view, partially in section, showing the position of the intercalary locking means of FIG. 10 before their insertion in the bore of the injector; and

FIG. 13 is a side view, partially in section, showing the position of the intercalary locking means of FIG. 10 after their insertion in the bore of the injector. A part of FIG. 13 is shown to a larger scale to better display the details.

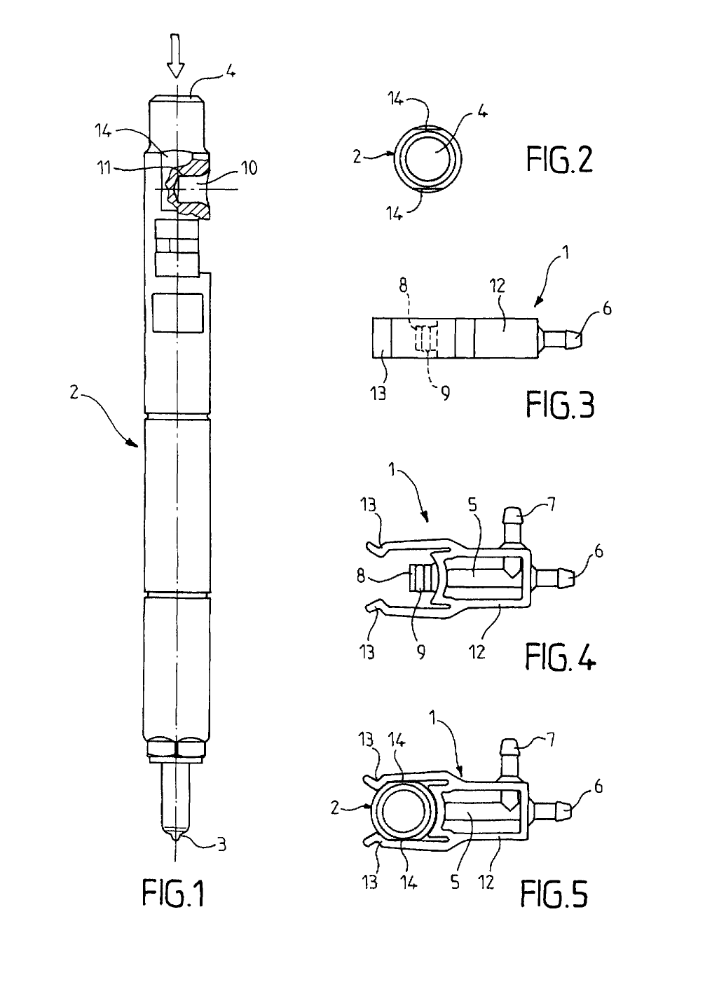

### DESCRIPTION OF THE EMBODIMENT OF THE INVENTION

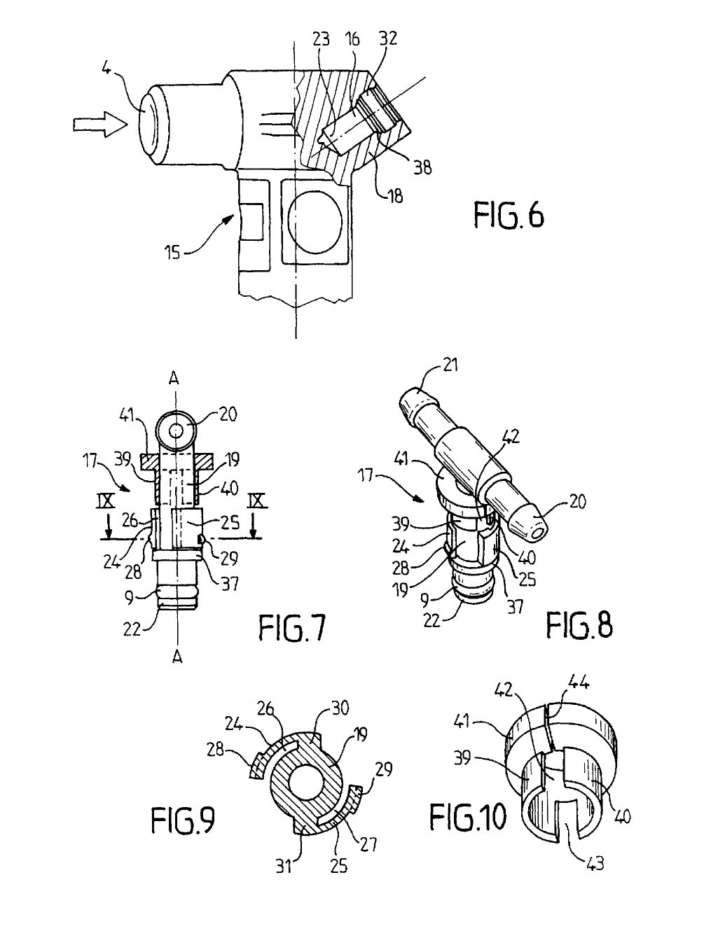

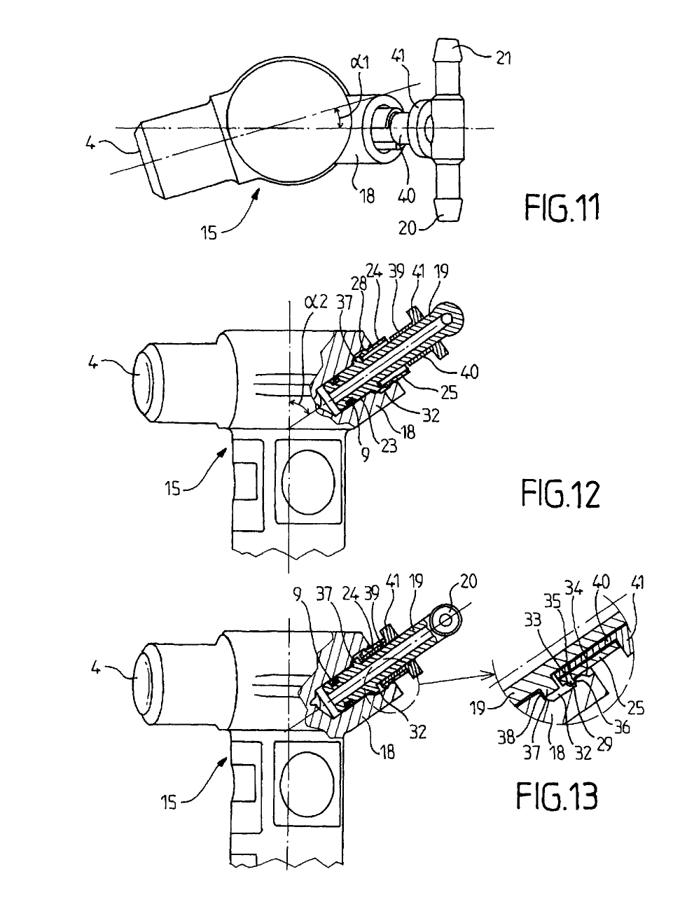

FIG. 6 shows a part of an injector 15 of the type fitted to an internal combustion engine. This injector 15 has a radial intake 4 for fuel at high pressure and it is provided with a bore 16 suitable to receive a quick connection union 17 in accordance with the invention as shown in FIGS. 7 and 8. The bore 16 is formed in a pipe 18 at a rear end of the injector 15 and is in communication with the inside of this.

The union 17, which in the example shown is a T-union, includes a generally cylindrical hollow body 19 presenting at a rear end connection means 20, 21 permitting connection of the union to a fuel return pipe (not shown).

At a front end, the body 19 presents a tubular nozzle 22 provided with sealing means in the form of an O-ring seal 9. The nozzle 22 is able to be received in a housing 23 at the bottom of the bore 16 (see FIG. 12).

The body 19 bears means for retaining the nozzle 22 in the housing 23. In accordance with the invention, these retaining means include two elastic tabs 24, 25, in an arc of circle extending substantially concentrically with the axis A-A of the body.

Each of the elastic tabs 24, 25 defines with the periphery of the body 19 a slot in an arc of circle 26, 27 and carries at its free end a catching organ in the form of a protuberance 28, 29.

Each of the elastic tabs 24, 25 is joined to the body 19 by means of a radial flange 30, 31 on the body to offset the respective tab outwardly so that the thickness of the corresponding slot 26, 27 substantially corresponds to the thickness of the protuberance 28, 29. The flange 30 of the first tab 24 is arranged diametrically opposed to the flange 31 of the second tab 25.

The protuberances 28, 29 are able to enter a groove 32 formed in the rear part of the bore 16 and can, on introduction of the nozzle 22 of the union 17 into the bore 16 retract elastically towards the body 19 of the union, to then extend into the slot 32 due to the elastic return of the tabs 24, 25.

In order to facilitate introduction of the tabs 24, 25 into the bore 16 of the pipe 18 of the injector 15, the protuberances 28, 29 advantageously have an inclined lower surface 33 forming a ramp coming into contact with the edge around the opening of the bore 16 which can, in the same manner, include an annular surface 34 inclined by the same angle to better co-operate with the lower surface 33. These details are best shown in the enlargement of a part of FIG. 13.

In order to facilitate withdrawal of the tabs 24, 25 from the bore 16 of the pipe 18 of the injector 15, the protuberances 28, 29 advantageously also have an inclined upper surface 35 forming a ramp in contact with a surface 36 inclined by the same angle provided in the upper part of the groove 32.

In accordance with a modified embodiment not shown in the figures, the protuberances 28, 29 can quite simply present in section a segment of circle and, in this case, the inclined surfaces 34 and 36 are no longer indispensable. It is only necessary, in fact, to provide an outwardly domed shape in one way or another.

The union 17 also includes a collar 37 arranged on the periphery of the body 19 immediately after the tabs 24, 25, so as to delimit the forward bending of these on withdrawal of the nozzle 22 from the bore 16.

The collar 37 also acts as a stop by coming into abutment against a circular shoulder 38 delimiting the groove 32 downwardly in the bore 16. The location of the collar 37 relative to the shoulder 38 is such that it determines the length of introduction of the body 29 into the bore 16.

Moreover, the tabs 24, 25 are dimensioned to protrude from the bore 16 when the nozzle is in its housing 23 in the bore to allow their radial compression on removal of the union 17.

Advantageously, the cylindrical body 19, the connecting means 20, 21, the tabs 24, 25, the flanges 30, 31 and the collar 37 are made in one piece, for example by injection moulding of an elastic material such as polyamide.

In the example shown in the figures, the union 17 also includes intercalary organs 39, 40 for locking the tabs 24, 25. These locking organs 39, 40 have a shape in an arc of circle and they are able to be inserted in a respective slot 26, 27 after introduction of the nozzle 22 into the bore 16 to connect the union 17 to the injector 15. In this manner, the protuberances 28, 29 can no longer come out of the groove 32 and the tabs are thus locked inside the bore 16.

The locking organs 39, 40 are advantageously joined to the lower face of a ring 41 mounted slidingly on the body 19. The locking organs 39, 40 between them define downwardly open notches 42, 43 able to receive the flanges 30, 31 on introduction of the locking organs into the slots 26, 27. Preferably, the locking organs entirely fill the slots 26, 27, extending from one flange (30 or 31) to the next.

The locking organs 39, 40 thus form, with the ring 41, an assembly having the general form of a flanged sleeve which is advantageously made in one piece, also of elastic material. For mounting of this assembly on the body 19, the ring is split (44) up to one of the notches. This allows it to be mounted on the body 19 from the side.

The quick connection union 17 is particularly easy to install on the injector 15 from its state shown in FIG. 7, which shows the locking organs 39, 40 withdrawn from the slots. It is only then necessary to introduce the nozzle 22 of the union into the bore 16 until the protuberances 28, 29 come into contact with the edge of the bore and to then push so that the tabs 24, 25 are thus elastically pushed back radially inwardly. This introduction movement is continued until the collar 37 comes into abutment against the circular shoulder 38 of the bore, while simultaneously the protuberances 28, 29 come to be housed in the groove 32 so as to retain the union in this position.

At the same time, the tabs 24, 25 re-adopt the form shown in FIG. 9 and it is then possible to displace the locking organs 39, 40 downwardly by pushing on the ring 41 so that these organs enter the slots 26, 27 so as to entirely lock the tabs inside the bore 16. The locking organs 39, 40 thus provide dual security and there is no risk that the union can be disengaged unintentionally.

Uninstallation of the union 17 is also very simple. Firstly, the locking organs 39, 40 are displaced outwardly by pulling on the ring 41 and then, due to the fact that the tabs 24, 25 protrude from the bore 16, they can be pinched to remove the protuberances 28, 29 from the groove 32 of the bore and then the whole of the union is withdrawn without problem.

Of course, the invention is not limited to the embodiment shown and described, as a large number of modifications can be made by the man skilled in the art without thereby departing from the scope of the invention.

1. Quick connection union able to connect an injector of an internal combustion engine to a fuel return pipe, including a generally cylindrical hollow body presenting at a rear end means for connection to the said fuel return pipe, and at a front end a tubular nozzle bearing sealing means and able to be received in a housing formed in a bore on the periphery of the said injector in communication with the inside of this, the said body bearing means for retaining the said tubular nozzle in the said housing, characterised by the fact that the said retaining means include two elastic tabs in an arc of circle extending on the periphery of the said body substantially concentrically with its axis, each of the said tabs defining with the periphery of the said body a slot in an arc of circle open on one side, and by the fact that the said tabs are able to co-operate with a groove provided inside the said bore of the injector, the union also including intercalary organs for locking the tabs able to be inserted in a respective slot of the said slots, following introduction of the said nozzle into the said bore.

2. Quick connection union as described in claim 1, characterised by the fact that the said tabs bear at a free end a catching organ in the form of a protuberance able to enter the said groove.

3. Quick connection union as described in claim 1 or 2, characterised by the fact that a fixed end of each tab is joined to the said body by means of a radial flange on the said body.

4. Quick connection union as described in claim 3, characterised by the fact that the said radial flange of a first tab is arranged diametrically opposite the flange of a second tab.

5. Quick connection union as described in any one of claims 2 to 4, characterised by the fact that the thickness of the said protuberance substantially corresponds to the thickness of the said slot.

6. Quick connection union as described in any one of claims 3 to 5, characterised by the fact that the said protuberance has an outwardly domed shape.

7. Quick connection union as described in any one of the preceding claims, characterised by the fact that the said tabs are dimensioned to protrude from the said bore when the said nozzle is inserted in it.

8. Quick connection union as described in any one of the preceding claims, characterised by the fact that forward bending of the said tabs is delimited by a collar on the periphery of the said body.

9. Quick connection union as described in claim 8, characterised by the fact that the said collar is able to act as a stop against a circular shoulder in the said bore on introduction of the said nozzle into it.

10. Quick connection union as described in claim 8 or 9, characterised by the fact that the said body, the said connection means, the said tabs, the said flanges and the said collar are made in one piece.

11. Quick connection union as described in one of the preceding claims, characterised by the fact that the said locking organs have a shape in an arc of circle.

12. Quick connection union as described in claim 11, characterised by the fact that the said locking organs are joined to the lower face of a ring mounted slidingly on the said body.

13. Quick connection union as described in claim 12, characterised by the fact that the said locking organs define between them downwardly open cavities able to receive the said flanges on introduction of the said locking organs into the said slots.

14. Quick connection union as described in claim 12 or 13, characterised by the fact that the said ring is made of an elastic material and is split in order to allow it to be mounted on the said body from the side.

15. Quick connection union as described in any one of claims 11 to 14, characterised by the fact that the said locking organs extend in the said slots and up to the next tab.

16. Injector for internal combustion engine, characterised by the fact that it is associated with a union as described in any one of claims 1 to 15 and by the fact that it is suitable to co-operate with retaining means provided on the said union.
